(19) United States
(12) Patent Application Publication
(10) Pub. No.: US 2023/0055362 A1
(43) Pub. Date: Feb. 23, 2023

(54) MACHINING APPARATUS AND METHOD FOR ELECTROCHEMICALLY REMOVING COMPONENT LAYERS OF A COMPONENT

(71) Applicant: MTU Aero Engines AG, München (DE)

(72) Inventors: Roland Huttner, München (DE); Christian Doll, München (DE); Matthias Hillmann, München (DE)

(73) Assignee: MTU Aero Engines AG, München (DE)

(21) Appl. No.: 17/904,367

(22) PCT Filed: Feb. 10, 2021
(86) PCT No.: PCT/DE2021/000024

§ 371 Date: Aug. 16, 2022

(30) Foreign Application Priority Data
Feb. 21, 2020 (DE) 10 2020 202 236.4

(51) Int. Cl. B23H 7/30; B23H 3/10

(52) U.S. Cl. CPC B23H 7/30; B23H 3/10; B23H 2400/10; B23H 9/10

(57) ABSTRACT

The invention relates to a machining apparatus for electrochemically removing component layers of a component, having at least one electrode, which is mounted so as to be movable along at least one infeed axis, and having at least one auxiliary electrode, which is mounted so as to be movable along an auxiliary infeed axis, wherein a gap for arranging the component for electrochemically removing the component layers extends between the at least one electrode and the at least one auxiliary electrode. At least the infeed axis and a longitudinal extension direction of the gap enclose an acute angle with each other. The machining apparatus comprises at least one oscillation device (40), which is set up at least to move the at least one electrode in an oscillating manner along the infeed axis and relative to the at least one auxiliary electrode.

### BACKGROUND OF THE INVENTION

The invention relates to a machining apparatus for electrochemically removing component layers of a component, having at least one electrode, which is mounted so as to be movable along at least one infeed axis, and having at least one auxiliary electrode, which is mounted so as to be movable along an auxiliary infeed axis, wherein a gap for arranging the component for electrochemically removing the component layers extends between the at least one electrode and the at least one auxiliary electrode. A further aspect of the invention relates to a method for electrochemically removing component layers of a component using a machining apparatus.

Electrochemical material removal, which may also be referred to as ECM or as electrochemical machining, belongs to the so-called material-removing manufacturing methods. A further development of ECM is represented by PECM, also referred to as pulsed electrochemical machining. A special feature of electrochemical material removal lies in the fact that it can be produced in a contactless manner, that is, without contact between the tool and the component to be machined. In order to carry out the material removal using a machining apparatus for electrochemical material removal of component layers, the component can be polarized as anode and an electrode of the machining apparatus can be polarized as the cathode. Adjusted between the component and the electrode is a gap, through which an electrolyte can be conveyed for charge transport. In ECM, a flow of electrons is created between the cathode and the anode, as a result of which metal ions can be released out of the component. The released metal ions can enter into reactions at the anode with parts of the electrolyte. Residues formed in ECM or PECM, in particular metal hydroxides, can be flushed out of the gap by the electrolyte and hence removed from the gap.

In order to achieve an improved machining quality, in particular an improved surface quality, it is appropriate to ensure that the gap is adequately flushed out with the electrolyte, that is, in other words, to ensure an adequate flow of the electrolyte through the gap.

### SUMMARY OF THE INVENTION

The object of the present invention is to provide a machining apparatus as well as a method for electrochemically removing component layers of a component, on the basis of which an improved flushing of a gap between at least one electrode of the machining apparatus and the component to be machined is made possible.

This object is achieved by a machining apparatus as well as by a method of the present invention. Advantageous embodiments with expeditious further developments of the invention are discussed herein.

A first aspect of the invention relates to a machining apparatus for electrochemically removing component layers of a component, having at least one electrode, which is mounted so as to be movable along at least one infeed axis, and having at least one auxiliary electrode, which is mounted so as to be movable along an auxiliary infeed axis, wherein a gap for arranging the component for electrochemically removing the component layers extends between the at least one electrode and the at least one auxiliary electrode. The infeed axis and the auxiliary infeed axis can each be assigned to the machining apparatus. The electrode and the auxiliary electrode can be formed as respective cathodes. Accordingly, the electrode may also be referred to as a cathode and the auxiliary electrode may also be referred to as an auxiliary cathode. The machining apparatus can be designed, in particular, for PECM, which may also be referred to as pulsed electrochemical machining. Beyond this, the machining apparatus can be designed for PEM, which may also be referred to as precise electrochemical machining.

In accordance with the invention, it is provided that at least the infeed axis and a longitudinal extension direction of the gap enclose an acute angle with each other and that the machining apparatus comprises at least one oscillation device, which is set up at least to move the at least one electrode in an oscillating manner along the infeed axis and relative to the at least one auxiliary electrode. This is advantageous, because it is accordingly possible by use of the machining apparatus—in contrast to apparatuses for electrochemical material removal known from the prior art—to ensure a reliable flow of electrolyte through the gap, even for a complex outer geometry of the component.

The electrode and the auxiliary electrode can have respective surface regions, for example, whereby the respective surface regions can enclose respective surface angles with one another. In other words, the respective surface regions of the electrode can be just as angled with respect to one another as the respective surface regions of the auxiliary electrode. The surface regions of the auxiliary electrode may also be referred to below as auxiliary surface regions. The surface regions of the electrode or of the auxiliary electrode can each be employed for electrochemical material removal. In other words, it is possible for a corresponding flow of electrons to occur over these surface regions between the electrode or auxiliary electrode and the component during electrochemical material removal. By way of the electrode or auxiliary electrode formed in this way, it is possible for the component to have corresponding component surfaces that can enclose a component surface angle with one another. The surface angles and the component surface angles can have the same angular measure.

The invention is based on the realization that, owing to the acute angle between the infeed axis and the longitudinal extension direction of the gap, at least one gap narrowing in a region between the electrode and the component and a restricted flow of electrolyte through the gap associated therewith, at least in regions, can be prevented, because, owing to the acute angle between the infeed axis and the longitudinal extension direction of the gap, the gap narrowing can occur in a uniform manner during the oscillating movement of the electrode along the infeed axis, even over a total gap length of the gap. Accordingly, different gap zones with correspondingly different flow speeds of the electrolyte flowing through the gap can be prevented and hence a uniform flow through the gap can be ensured, as a result of which, in particular, an improved electrolyte exchange and thus an improved surface quality of the component as a result of the electrochemical material removal can be achieved.

A limited gap width of the gap, due to the electrode, on the one hand, and to the auxiliary electrode, on the other hand, can extend along a transverse extension direction that is oriented perpendicular to the longitudinal extension direction of the gap.

In an advantageous further development of the invention, the at least one oscillation device is additionally set up to move the at least one auxiliary electrode in an oscillating manner along the auxiliary infeed axis and relative to the at least one electrode. This is advantageous, because, accordingly, the removal on the component can hereby occur simultaneously by the electrode, on the one hand and by the auxiliary electrode, on the other hand, at component regions that lie opposite to one another.

In a further advantageous further development of the invention, the at least one oscillation device is set up to move the at least one electrode and the at least one auxiliary electrode synchronously relative to each other in an oscillating manner. This is advantageous, because it is thereby possible to achieve an especially uniform electrochemical removal by use of both the electrode and the auxiliary electrode.

In a further advantageous further development of the invention, the auxiliary infeed axis and the longitudinal extension direction enclose an acute auxiliary angle with each other. This is advantageous in order to ensure also an especially uniform flow of the electrolyte between the auxiliary electrode and the component.

In a further advantageous further development of the invention, the angle and the auxiliary angle have the same angular measure. This is advantageous, because it is thereby possible for an especially symmetrical electrochemical material removal to occur. The angle measure can be designed as a linear angle measure. Preferably, the angle measure can correspond to a value of 45°. The angle and the auxiliary angle can then jointly and thus in sum total form a right angle. This is advantageous particularly when respective component regions of the component that are to be machined by the electrochemical material removal are likewise oriented at a right angle to one another.

In another advantageous further development of the invention, the longitudinal extension direction of the gap is oriented perpendicular to an adjustment axis assigned to the machining apparatus, along which the electrode and the auxiliary electrode are movable relative to each other and with a change in a gap width of the gap. This is advantageous, because, owing to the orientation of the longitudinal extension direction of the gap and the adjustment axis relative to each other, an especially fast change in the gap width of the gap can occur. The electrode and the auxiliary electrode can be moved along the adjustment axis directly, in particular along the shortest possible path, towards each other and away from each other, as a result of which the fast change in the gap width of the gap is made possible. For example, the oscillation device or a movement device of the machining apparatus can be designed to move the electrode and the auxiliary electrode along the common adjustment axis relative to each other, that is, towards each other and away from each other. This can helpful in order to align the electrode and the auxiliary electrode prior to the electrochemical material removal, that is, prior to the machining of the component, relative to each other and, additionally or alternatively, relative to the component and thereby to adjust, for example, a maximum value of the gap width prior to the machining.

In another advantageous further development of the invention, the machining apparatus comprises at least one flushing device for flushing out at least one gap region of the gap with an electrolyte. This is advantageous, because, accordingly, no separate, in particular external, flushing apparatuses for flushing out the gap are needed. The electrolyte can preferably be designed as sodium nitrate. The flushing of the gap can flush out removed products, such as, for example, metal hydroxides, from the gap.

In another advantageous further development of the invention, the at least one oscillation device is set up to at least move the at least one electrode in an oscillating manner with an oscillation frequency of between 15 Hz and 60 Hz, preferably of between 20 Hz and 40 Hz, and especially preferably of between 28 Hz and 32 Hz. Beyond this, the at least one oscillation device is also set up to move the at least one auxiliary electrode in an oscillating manner with the oscillation frequency of between 15 Hz and 60 Hz, preferably of between 20 Hz and 40 Hz, and especially preferably of between 28 Hz and 32 Hz. This oscillation frequency enables the electrochemical material removal to be carried out especially as needed, that is, for example, to create a surface quality of the component by the electrochemical material removal especially as needed. Hereby understood are also values of the oscillation frequency of 15.0 Hz, 15.5 Hz, 16.0 Hz, 16.5 Hz, 17.0 Hz, 17.5 Hz, 18.0 Hz, 18.5 Hz, 19.0 Hz, 19.5 Hz, 20.0 Hz, 20.5 Hz, 21.0 Hz, 21.5 Hz, 22.0 Hz, 22.5 Hz, 23.0 Hz, 23.5 Hz, 24.0 Hz, 24.5 Hz, 25.0 Hz, 25.5 Hz, 26.0 Hz, 26.5 Hz, 27.0 Hz, 27.5 Hz, 28.0 Hz, 28.5 Hz, 29.0 Hz, 29.5 Hz, 30.0 Hz, 30.5 Hz, 31.0 Hz, 31.5 Hz, 32.0 Hz, 32.5 Hz, 33.0 Hz, 33.5 Hz, 34.0 Hz, 34.5 Hz, 35.0 Hz, 35.5 Hz, 36.0 Hz, 36.5 Hz, 37.0 Hz, 37.5 Hz, 38.0 Hz, 38.5 Hz, 39.0 Hz, 39.5 Hz, 40.0 Hz, 40.5 Hz, 41.0 Hz, 41.5 Hz, 42.0 Hz, 42.5 Hz, 43.0 Hz, 43.5 Hz, 44.0 Hz, 44.5 Hz, 45.0 Hz, 45.5 Hz, 46.0 Hz, 46.5 Hz, 47.0 Hz, 47.5 Hz, 48.0 Hz, 48.5 Hz, 49.0 Hz, 49.5 Hz, 50.0 Hz, 50.5 Hz, 51.0 Hz, 51.5 Hz, 52.0 Hz, 52.5 Hz, 53.0 Hz, 53.5 Hz, 54.0 Hz, 54.5 Hz, 55.0 Hz, 55.5 Hz, 56.0 Hz, 56.5 Hz, 57.0 Hz, 57.5 Hz, 58.0 Hz, 58.5 Hz, 59.0 Hz, 59.5 Hz, 60.0 Hz, as well as corresponding intermediate values.

In another advantageous further development of the invention, the at least one oscillation device is set up to move at least the at least one electrode in an oscillating manner with a vibrational amplitude of between 0.2 mm and 0.5 mm, preferably of between 0.3 mm and 0.4 mm, and especially preferably of between 0.32 mm and 0.38 mm. Beyond this, the at least one oscillation device can also be set up to move also the at least one auxiliary electrode in an oscillating manner with a vibrational amplitude of between 0.2 mm and 0.5 mm, preferably of between 0.3 mm and 0.4 mm, and especially preferably of between 0.32 mm and 0.38 mm. This vibrational amplitude enables the electrochemical material removal to be carried out especially as needed, that is, for example, to create a surface quality of the component by the electrochemical material removal especially as needed. Hereby understood are also values of the vibrational amplitude of 0.20 mm, 0.21 mm, 0.22 mm, 0.23 mm, 0.24 mm, 0.25 mm, 0.26 mm, 0.27 mm, 0.28 mm, 0.29 mm, 0.30 mm, 0.31 mm, 0.32 mm, 0.33 mm, 0.34 mm, 0.35 mm, 0.36 mm, 0.37 mm, 0.38 mm, 0.39 mm, 0.40 mm, 0.41 mm, 0.42 mm, 0.43 mm, 0.44 mm, 0.45 mm, 0.46 mm, 0.47 mm, 0.48 mm, 0.49 mm, as well as corresponding intermediate values.

A second aspect of the invention relates to a method for electrochemically removing component layers of a component using a machining apparatus, wherein the machining apparatus comprises at least one electrode, which is mounted so as to be movable along at least one infeed axis, and wherein the machining apparatus comprises at least one auxiliary electrode, which is mounted so as to be movable along an auxiliary infeed axis, wherein a gap extends between the at least one electrode and the at least one auxiliary electrode, in which the component for electrochemical material removal of the component layers is arranged. In accordance with the invention, it is provided that at least the infeed axis and a longitudinal extension direction of the gap enclose an acute angle with each other and that the machining apparatus comprises at least one oscillation device, by which at least the at least one electrode for electrochemical material removal of the component layers is moved in an oscillating manner along the infeed axis and relative to the at least one auxiliary electrode. The features presented in connection with the machining apparatus according to the invention in accordance with the first aspect of the invention as well as the advantages thereof apply correspondingly to the method according to the invention in accordance with the second aspect of the invention and vice versa.

Further features of the invention ensue from the claims and the exemplary embodiments. The features and combinations of features mentioned above in the description as well as the features and combinations of features mentioned below in the exemplary embodiments and/or alone can be used not only in the respectively given combination, but also in other combinations or alone, without leaving the scope of the invention. Accordingly, embodiments of the invention are also regarded as comprised and disclosed that are not explicitly shown and explained in the exemplary embodiments, but which ensue and can be produced by separate combinations of features from the explained embodiments. Embodiments and combinations of features that accordingly do not have all features of an independent claim as originally formulated are also to be regarded as disclosed.

### BRIEF DESCRIPTION OF THE DRAWING FIGURES

Hereby shown are:

FIG. 1 is a schematic sectional depiction of a partial region of a machining apparatus for electrochemical material removal of component layers of a component, which is likewise shown in a schematic sectional depiction, whereby an electrode and an auxiliary electrode of the machining apparatus are moved relative to the component in an oscillating manner and have a minimum distance from the component adjusted during the electrochemical removal; and

FIG. 2 is another schematic sectional depiction of the partial region of the machining apparatus and of the component, whereby the electrode and the auxiliary electrode have a minimum distance from the component adjusted during the electrochemical removal.

### DESCRIPTION OF THE INVENTION

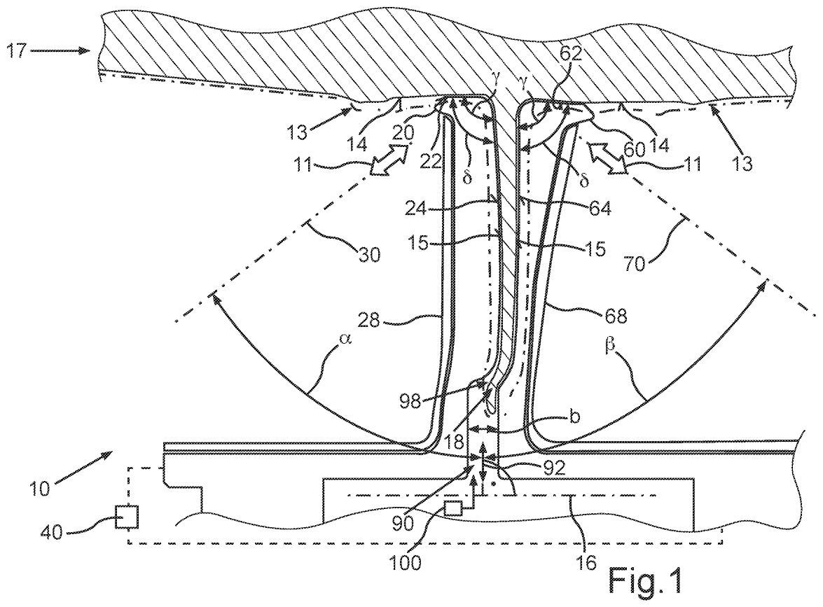

FIG. 1 shows, in a schematic sectional depiction, a partial region of a machining apparatus 10. which is designed for PECM machining. The machining apparatus 10 accordingly serves for electrochemically removing component layers of a component 12. The component 12 can be designed, as is the case in the present example, as a rotor for a turbomachine or at least as a component for such a rotor. In the present case, the component 12 comprises a partially depicted annular region 17 and a plurality of blade elements 18, of which in FIG. 1, only one blade element 18, depicted in a partially sectional manner, can be seen. The annular region 17 here corresponds to one component region of the component 12, whereas the blade element 18 corresponds to another component region of the component 12. The blade elements 18 may also be referred to as “airfoils.” The annular region 17 may also be referred to as an annular space.

Also shown in FIG. 1 is a pre-machining state 13 of the component 12, which is depicted by a dot-dash line. In this case, the pre-machining state 13 shows a component geometry of the component 12 prior to the start of the electrochemical material removal by the machining apparatus 10. In addition, FIG. 1 shows the component 12 during the machining using the machining apparatus 10, whereby several of the component layers of the component 12 have already been electrochemically removed.

The machining apparatus 10 comprises an electrode 20, which is mounted so as to be movable along an infeed axis 30. The infeed axis 30 may also be referred to as the X1 axis. Beyond this, the machining apparatus 10 comprises an auxiliary electrode 60, which is mounted so as to be movable along an auxiliary infeed axis 70. The auxiliary infeed axis 70 may also be referred to as the X2 axis. Between the electrode 20 and the auxiliary electrode 60, there extends a gap 90 for arrangement of the component 12 for electrochemical material removal of the component layers. In the present example, the blade element 18 is mounted in the gap 90 for its electrochemical machining by material removal. Arranged on the electrode 20 is an electrical insulation 28 for protection against short circuits. Arranged correspondingly on the auxiliary electrode 60 is an auxiliary electrical insulation 68, which likewise serves for protection against short circuits.

The infeed axis 30 and a longitudinal extension direction 92 of the gap 90 enclose an acute angle α with each other. On the other hand, the auxiliary infeed axis 70 and the longitudinal extension direction 92 of the gap 90 enclose an acute auxiliary angle β with each other. In the present example, the angle α and the auxiliary angle β have the same angle measure of 45°.

The machining apparatus 10 comprises an oscillation device 40, which is set up, on the one hand, to move the electrode 20 in an oscillating manner along the infeed axis 30 and relative to the auxiliary electrode 60. On the other hand, the oscillation device 40 is set up to move the auxiliary electrode 60 in an oscillating manner along the auxiliary infeed axis 70 and relative to the electrode 20. By use of the oscillation device 40, the electrode 20 and the auxiliary electrode 60 can be moved synchronously relative to each other in an oscillating manner, as a result of which the component 12 can be subjected to uniform electrochemical material removal, at least in regions, both by use of the electrode 20 and by use of the auxiliary electrode 60.

The oscillation device 40 can also move, in general, both the electrode 20 and the auxiliary electrode 60 for their respective infeed, that is, the electrode 20 along the infeed axis 30 and the auxiliary electrode 60 along the auxiliary infeed axis 70 towards the component 12 as well as away from the component 12. In other words, the oscillation device 40 can be set up, in general, to infeed both the electrode 20 and the auxiliary electrode 60. The infeed may also be referred to as advance.

The oscillation device 40 is set up to move both the electrode 20 and the auxiliary electrode 60 in an oscillating manner in each instance, with an oscillation frequency of between 15 Hz and 60 Hz, inclusive of both limits. Beyond this, the oscillation device 40 is set up to move both the electrode 20 and the auxiliary electrode 60 in an oscillating manner in each instance, with a vibrational amplitude of between 0.2 mm and 0.5 mm, inclusive of both limits.

The longitudinal extension direction 92 of the gap 90 is oriented perpendicular to an adjustment axis 16, which is assigned to the machining apparatus 10 and along which the electrode 20 and the auxiliary electrode 60 are movable relative to each other and with a change in a gap width b of the gap 90.

In FIG. 1, the gap width b is minimal, as a result of which, on the one hand, between the electrode 20 and the blade element 18 and, on the other hand, between the auxiliary electrode 60 and the blade element 18, an especially narrow gap region 98 extends in each instance, through which an electrolyte, such as, for example, sodium nitrate, can be conveyed using a flushing device 100 of the machining apparatus 10 in order to thereby flush out residues, in particular metal hydroxides, from the gap regions 98 and thus to flush them out of the gap 90. As a result of a respective oscillating movement 11 of the electrode 20 as well as of the auxiliary electrode 60, which is depicted by a double arrow and is produced by the oscillation device 40, the gap width b is accordingly also increased and reduced in size, as a result of which a respective gap region width of the gap width 98 is also changed accordingly.

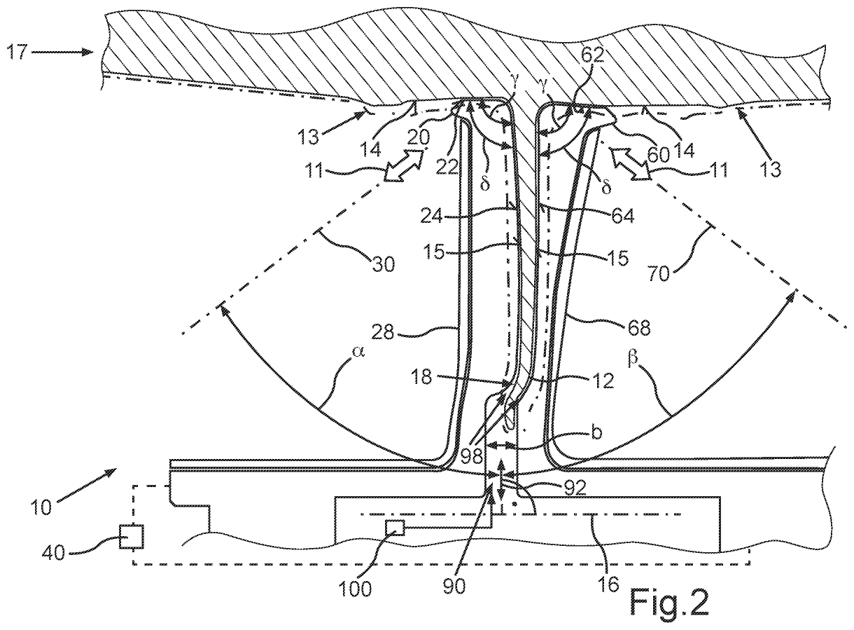

In FIG. 2, in contrast to FIG. 1, the gap width b in consequence of the oscillating movement 11 is maximal, as a result of which the respective gap region width of the gap regions 98 is also larger than in FIG. 1.

On the basis of FIG. 2, it can clearly be seen that the component 12 has respective component surfaces 14, 15, which face, on the one hand, the electrode 20 and, on the other hand, the auxiliary electrode 60 and which enclose component surface angles γ with each other. The electrode 20 has respective surface regions, namely, a first surface region 22 and a second surface region 24. In contrast, the auxiliary electrode 60 has respective auxiliary surface regions, namely, a first auxiliary surface region 62 and a second auxiliary surface region 64. Both the surface regions 22, 24 and the auxiliary surface regions 62, 64 each enclose a surface angle δ. The surface angles δ and the component surface angles γ can each have here the same angle measure, such as, for example, 90°.

Owing to the possibility of an oscillating movement 11 of the electrode 20 at the angle α (here: 45°) and of the auxiliary electrode 60 at the angle β (here: 45°) relative to the longitudinal extension direction 92, it is possible in an especially advantageous manner to ensure a uniform gap narrowing and gap broadening, that is, in other words, to ensure a uniform change in the gap width b, in particular at a transition from the blade element 18 to the annular region 17 between the electrode 20 and the component 12, on the one hand, and between the auxiliary electrode 60 and the component 12, on the other hand, during the oscillating movement 11 within the scope of the electrochemical material removal of the component layers. The uniform change in the gap width b at the transition region is seen especially clearly by viewing FIG. 1 and FIG. 2 together. Owing to the uniform change in the gap width b, it is accordingly possible to ensure a uniform flushing of the respective gap regions 98 with the electrolyte.

Whereas conventional PECM systems for the machining of blade elements operated with horizontal axes for an infeed direction of the blade element and with a possibility of infeeding in a height direction and thus in the direction of the annular space, the present machining apparatus 10 makes possible the oscillating movement 11 and infeeding at respective angles (angle α, auxiliary angle β), which, for example, each can have an angle measure of 45°. Accordingly, by use of the present machining apparatus 10, the oscillating movement 11 both of the electrode 20 and of the auxiliary electrode 60 occurs both horizontally and simultaneously vertically. The gap width b of the gap 90 can thereby be varied uniformly along the component 12 during the oscillating movement 11, so that a correspondingly uniform flushing of the gap 90 or of the gap regions 98 with the electrolyte can be ensured and thus an especially high machining quality, in particular an especially high surface quality, can be achieved.

Overall, the machining apparatus 10 makes possible both the oscillation, that is, the oscillating movement 11, and the infeed both of the electrode 20 and of the auxiliary electrode 60 at 45° and thus an optimized exchange of the electrolyte that is conveyed through the gap by use of the flushing device 100. Owing to the machining apparatus 10, it is accordingly possible to prevent any passivation at the component 12 and to carry out a faster PECM machining of the component 12. Utilization of the machining apparatus 10 makes it possible to prevent any formation of unexpected interfering contours on the component 12 in consequence of the oscillating movement 11, because a retraction of the electrode 20 and of the auxiliary electrode 60 on a machine path, that is, along the infeed axis 30 or the auxiliary infeed axis 70 and away from the component 12, can be produced. Beyond this, it is possible by use of the machining apparatus 10 for a parallel machining of the component 12 both by using the electrode 20 and by using the auxiliary electrode 60 to take place, as a result of which the electrochemical material removal of the component layers can be carried out in an especially time-saving manner. In particular, the electrochemical material removal of the component layers of the component 12 using the machining apparatus 10 can be conducted exclusively by movement (infeeding and oscillating movement 11) of the electrode 20 along the infeed axis 30 (X1 axis) and of the auxiliary electrode 60 along the auxiliary infeed axis 70 (X2 axis).

1. A machining apparatus for electrochemically removing component layers of a component, having at least one electrode, which is mounted to be movable along at least one infeed axis, and having at least one auxiliary electrode, which is mounted so as to be movable along an auxiliary infeed axis, wherein a gap for arranging the component for electrochemically removing the component layers extends between the at least one electrode and the at least one auxiliary electrode, wherein at least the infeed axis and a longitudinal extension direction of the gap enclose an acute angle with each other and the machining apparatus comprises at least one oscillation device, which is configured at least to move the at least one electrode in an oscillating manner along the infeed axis and relative to the at least one auxiliary electrode.

2. The machining apparatus according to claim 1, wherein the at least one oscillation device is additionally configured to move the at least one auxiliary electrode in an oscillating manner along the auxiliary infeed axis and relative to the at least one electrode.

3. The machining apparatus according to claim 2, wherein the at least one oscillation device is configured to move the at least one electrode and the at least one auxiliary electrode synchronously relative to each other in an oscillating manner.

4. The machining apparatus according to claim 2, wherein the auxiliary infeed axis and the longitudinal extension direction enclose an acute auxiliary angle with each other.

5. The machining apparatus according to claim 4, wherein the angle and the auxiliary angle have the same angle measure.

6. The machining apparatus according to claim 1, wherein the longitudinal extension direction of the gap is oriented perpendicular to an adjustment axis, which is assigned to the machining apparatus and along which the electrode and the auxiliary electrode moves relative to each other and with change in a gap width of the gap.

7. The machining apparatus according to claim 1, wherein the machining apparatus comprises at least one flushing device for flushing out at least one gap region of the gap with an electrolyte.

8. The machining apparatus according to claim 1, wherein the at least one oscillation device is configured to move at least the at least one electrode in an oscillating manner with an oscillation frequency of between 15 Hz and 60 Hz.

9. The machining apparatus according to claim 1, wherein the at least one oscillation device is configured to move at least the at least one electrode in an oscillating manner with a vibrational amplitude of between 0.2 mm and 0.5 mm.

10. A method for electrochemically removing component layers of a component using a machining apparatus, wherein the machining apparatus comprises at least one electrode, which is mounted so as to be movable along at least one infeed axis, and wherein the machining apparatus comprises at least one auxiliary electrode, which is mounted so as to be movable along an auxiliary infeed axis, wherein a gap extends between the at least one electrode and the at least one auxiliary electrode, wherein the component is arranged for electrochemical material removal of the component layers, wherein at least the infeed axis and a longitudinal extension direction of the gap enclose an acute angle with each other and the machining apparatus comprises at least one oscillation device, by which at least the at least one electrode for electrochemical material removal of the component layers is moved in an oscillating manner along the infeed axis and relative to the at least one auxiliary electrode.
